(19) United States
(12) Patent Application Publication
(10) Pub. No.: US 2015/0333925 A1
(43) Pub. Date: Nov. 19, 2015

(54) Conservosmart

(71) Applicants: Ross Gregory Murray, Murrieta, CA (US); Michael Ross Ingraham, Murrieta, CA (US)

(72) Inventors: Ross Gregory Murray, Murrieta, CA (US); Michael Ross Ingraham, Murrieta, CA (US)

(21) Appl. No.: 14/179,489

(22) Filed: May 15, 2014

(51) Int. Cl. H04L 12/28; H04L 29/08

(52) U.S. Cl. CPC H04L 12/2823; H04L 67/10

(57) ABSTRACT

Conservosmart is an application that gathers electrical usage data from household appliances, interpolates the data, predicts future electrical usage for household appliances, and gives suggestions on when to use household appliances in order to save kWh's of usage and/or prevent city-wide electrical blackouts. The main components of Conservosmart are the API capable of running on an operating system, which is how the household appliances communicate to the cloud server, which is where the data is gathered and interpolated.

Other components of Conservosmart are API Links, which are for all the electrical suppliers, the mobile application, which is used by the end-user to receive their information, and the Internet, which is how all these components connect.

### CROSS-REFERENCE TO RELATED APPLICATIONS

Application No. 61/933663

Filing or 371(c) DATE: Jan. 30, 2014

### STATEMENT REGARDING FEDERALLY SPONSORED RESEARCH OR DEVELOPMENT

None

### THE NAMES OF THE PARTIES TO A JOINT RESEARCH AGREEMENT

None

### REFERENCE TO A “SEQUENCE LISTING,” A TABLE, OR A COMPUTER PROGRAM

None

### BACKGROUND OF THE INVENTION

Ross G. Murray and Michael R. Ingraham had the idea of helping electrical users and their electrical companies be able to conserve electricity and, in turn, cut down costs by taking advantage of the any Operating System technology already used in the world.

### BRIEF SUMMARY OF THE INVENTION

Our invention creates an application that resides on household appliances that incorporate an any Operating System that is used to either control or manage the household appliance; for example, all household appliances that run on electricity such as refrigerator, television, coffee maker, etc. The application would gather the data from the household appliance and transmit to the cloud the electrical kWh usage per appliance per instant of time to predict the amount of kWh needed to maintain an efficient electrical usage of household appliances for the future and to prevent city-wide blackouts. Calculations of predictable power usage will be instantaneously available to both power companies as suppliers and household owners as customers. Power companies will be able to better predict usage per minute of time. Customers will be able to better control/conserve through mobile applications instantly reporting both usage and predictable usage per household appliance over any period in the future.

### BRIEF DESCRIPTION OF THE SEVERAL VIEWS OF THE DRAWING

FIG. 1: These are examples of household appliances that come embedded with an operating system. The collected data will be sent to a Cloud Server to be interpreted; the interpreted predictable data will then be available to household owners as end users and electrical grid operators as suppliers of electricity. Electrical Supplier: Electrical Supplier. Example: Southern California Edison (SCE), Pacific Gas and Electric Company, and Georgia Power. End User: Household Appliance User. Example: Household appliance user that uses a household appliance (example: microwave).

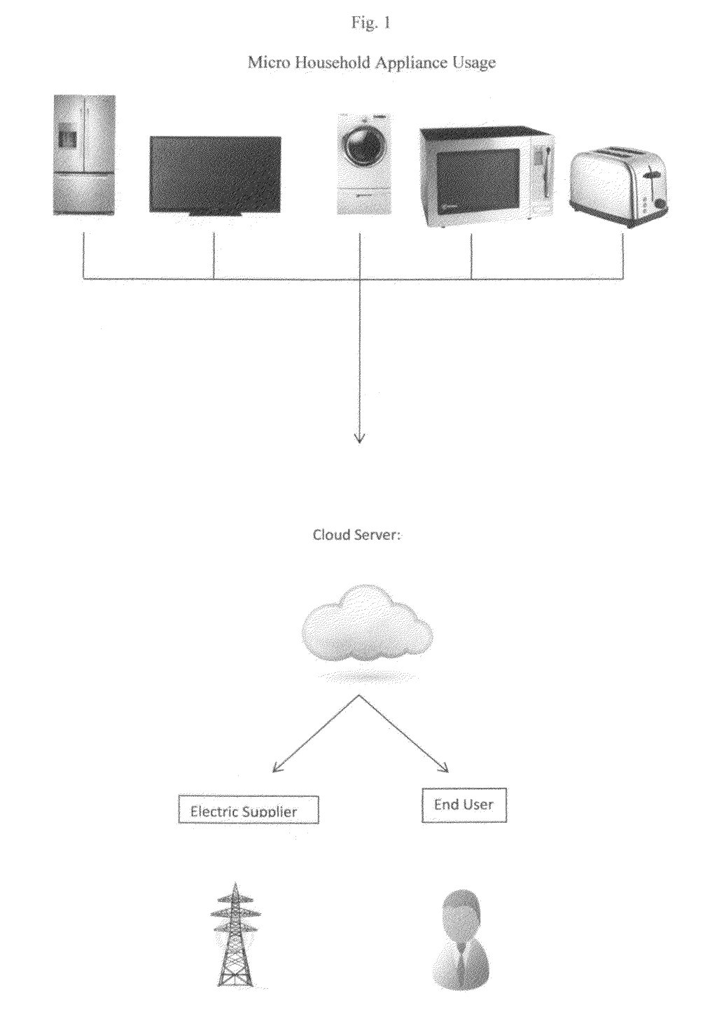

FIG. 2: These are examples of houses (although this is just an example, for we can use anyone that uses household appliances no matter where they use the household appliances, whether they own the house, apartment, or space, etc.) that come embedded with an operating system that is incorporated into the appliance. The collected data will be sent to a Cloud Server to be interpreted; the interpreted predictable data will then be available to household owners as end users and electrical grid operators as suppliers of electricity. Electrical Supplier: Electrical Supplier. Example: Southern California Edison (SCE), Pacific Gas and Electric Company, and Georgia Power. End User: Household Appliance User. Example: Household appliance user that uses a household appliance (example: microwave).

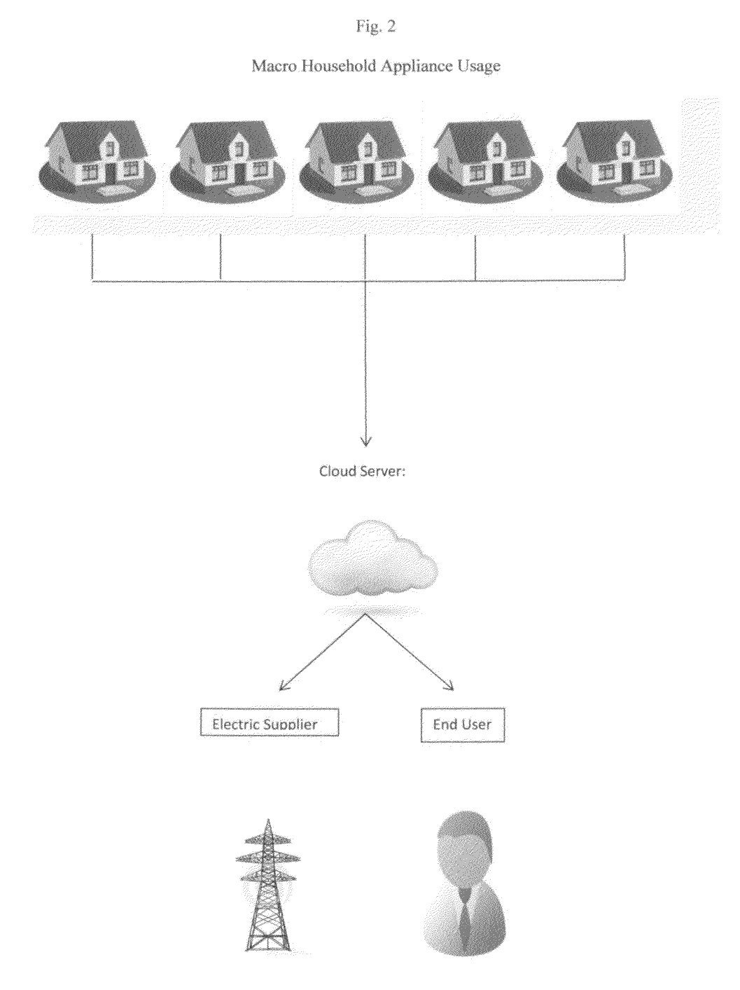

FIG. 3: These are examples of states that contain household appliance users that use household appliances that come embedded with an operating system. The collected data will be sent to a Cloud Server to be interpreted; the interpreted predictable data will then be available to household owners as end users and electrical grid operators as suppliers of electricity. Electrical Supplier: Electrical Supplier. Example: Southern California Edison (SCE), Pacific Gas and Electric Company, and Georgia Power. End User: Household Appliance User. Example: Household appliance user that uses a household appliance (example: microwave).

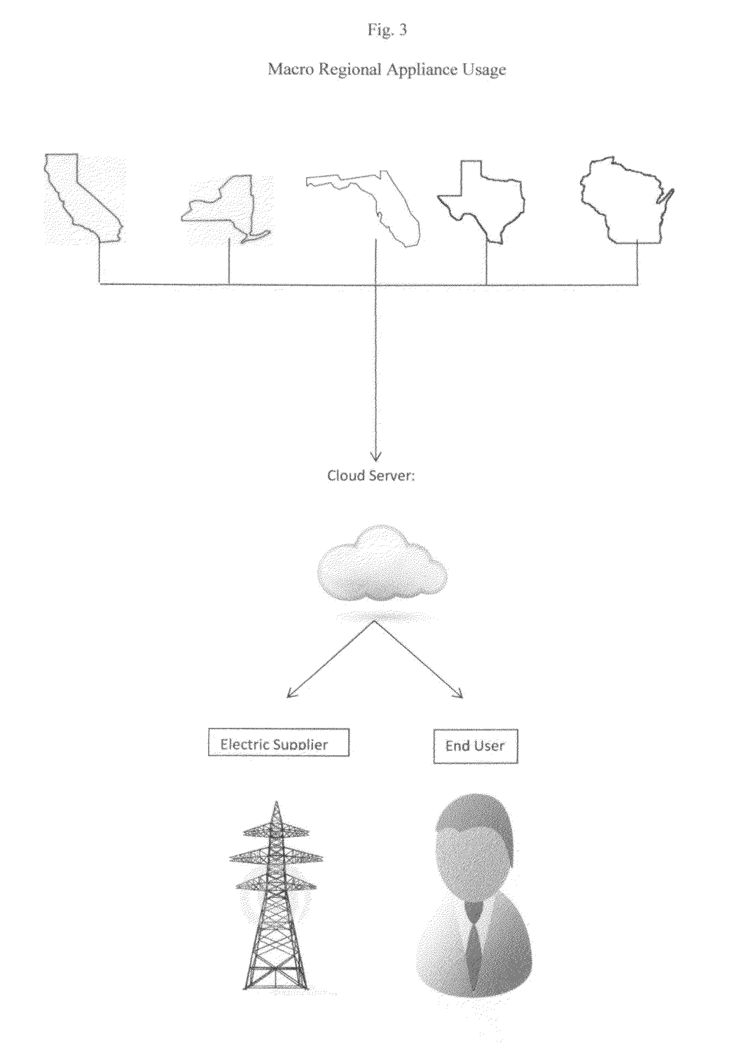

FIG. 4: This is an example of a kWh reading of a certain household appliance being used by any household appliance user. Each variable is a specific point in time (second, minute, hour, etc.) when the kWh reading was taken. These equations have a denominator of 7 because the variables each represent days in time in which readings were taken (for the sake of a simple example). There are 7 days in a week, so dividing the sum of the 7 readings by 7 gives us an average for the week. This can be applied and tweaked depending on what each variable represents, in regards to the amount of time it encompasses. The reason for the deletion of the first reading and the addition of another reading is to create a fluid model of average kWh usage of a certain time period (again, depending on the definition of each variable). This accounts for possible data skews and prevents possible data skews. Therefore, this information will allow for an end user, such as the household appliance users as customers, to know how much kWh is being used per appliance per amount of time being analyzed.

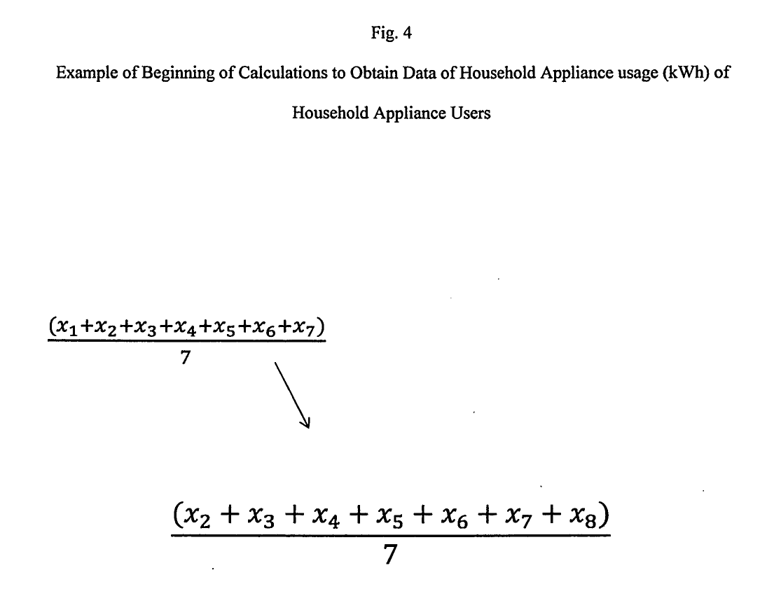

### DETAILED DESCRIPTION OF THE INVENTION

The invention operates by taking the instantaneous kWh usage per appliance of electrical household appliances running on an operating system per second in a twenty-four hour time period for a house. Our program will do this by reading the time the electrical household appliance running on an operating system is on or off in an instant of time. Then, the program will read the ID of the electrical household appliance running on an operating system, which includes the make of the electrical household appliance running on an operating system and the model of the electrical household appliance running on an operating system. Next, our program will use the electrical household appliance running on an operating system's manufacturer's database to calculate the kWh usage of the electrical household appliance running on an operating system in a given instant of time and period of time, to allow the user to know how much electrical energy that the user is using in a particular instant and/or period of time by sending the information to a mobile application available for download from Conservosmart. Furthermore, if the electrical household appliance running on an operating system is capable of reading the kWh usage, our program will read the electrical household appliance running on an operating system's usage. Our program will accomplish these tasks by completing an algorithm based upon random predictability calculations of the amount of kWh usage of an electrical household appliance running on an operating system per instant of time per item per household.

1. We claim that our invention creates an application that resides on household appliances that incorporate an operating system that is used to either control or manage the household appliance; for example, all household appliances that run on electricity such as refrigerator, television, coffee maker, etc: The application would gather the data from the household appliance and transmit to the “cloud” the electrical kWh usage per appliance per instant of time to predict the amount of kWh needed to maintain an efficient electrical usage of household appliances for the future and to prevent city-wide blackouts. Calculations of predictable power usage will be instantaneously available to both power companies as suppliers and household owners as customers. Power companies will be able to better predict usage per minute of time. Customers and power companies will be able to better control/conserve through mobile applications instantly reporting both usage and predictable usage per household appliance over any period in the future. The parts and components of our invention, which connect through the Internet, include an operating system as supplied by the appliance manufacturer, a cloud-based server to gather and interpolate the data, API Links for all electrical suppliers, and mobile applications for all customers to review usage and control electrical household appliances controlled by the provided operating system with conservation as a planned usage. The invention operates by taking the instantaneous kWh usage per appliance of electrical household appliances running on an operating system per second in a twenty-four hour time period for a house. Our program will do this by reading the time the electrical household appliance running on an operating system is on or off in an instant of time. Then, the program will read the ID of the electrical household appliance running on an operating system, which includes the make of the electrical household appliance running on an operating system and the model of the electrical household appliance running on an operating system. Next, our program will use the electrical household appliance running on an operating system's manufacturer's database to calculate the kWh usage of the electrical household appliance running on an operating system in a given instant of time and period of time, to allow the user to know how much electrical energy that the user is using in a particular instant and/or period of time by sending the information to a mobile application available for download from Conservosmart. Furthermore, if the electrical household appliance running on an operating system is capable of reading the kWh usage, our program will read the electrical household appliance running on an operating system's usage. In all cases, a conversion of kWh usage to cost will be provided via the mobile application to more easily make the data understood economically to the user. Our program will accomplish these tasks by completing an algorithm based upon directed predictability calculations of the amount of kWh usage of an electrical household appliance running on an operating system per instant of time per item per household. Therefore, our invention calculates interpretations of predictable data from electrical household appliances running on an operating system that will be instantaneously available for both power suppliers and/or power companies, as suppliers, and household owners, as customers, allows power companies to be able to better predict kWh usage per minute of time per electrical household appliances running on an operating system, allows customers to be able to better control/conserve electrical power through mobile applications that instantly report both kWh usage and predictable kWh usage over any period of time in the future for electrical household appliances running on an operating system, and allows home owners to choose better times in a day to run an appliance to aid in the conservation of energy during high peak periods.
